(19) United States
(12) Patent Application Publication
(10) Pub. No.: US 2022/0080474 A1
(43) Pub. Date: Mar. 17, 2022

(54) Method and equipment to perform controlled access to the projected location inside a storage tank, while it is operated, idle, or undergoing maintenance, to conduct an internal service from outside

(71) Applicants: Sergey Timoshchenko, Edmonton (CA); Ravil Ibatullin, Calgary (CA)

(72) Inventors: Sergey Timoshchenko, Edmonton (CA); Ravil Ibatullin, Calgary (CA)

(21) Appl. No.: 17/484,013

(22) Filed: Sep. 24, 2021

Related U.S. Application Data
(60) Provisional application No. 63/148,976, filed on Feb. 12, 2021.

(51) Int. Cl. B08B 9/08; B01D 21/00; B08B 13/00; B05D 7/22

(52) U.S. Cl. CPC B08B 9/0813; B01D 21/0006; B08B 2209/08; B05D 7/227; B08B 9/0808; B08B 13/00

(57) ABSTRACT

Method and equipment to perform controlled access to the projected location inside a storage tank, while it is operated, idle, or undergoing maintenance, to conduct an internal service from outside. This intervention from outside can be performed through an access opening in the wall or roof of the tank. In addition to other innovations, a new coiled tubing (CT) solution for multiple 3D positioning arrangements outside and inside the tank is provided for both positioning, inserting, remote control, and withdrawing the CT with the active head for the controlled accessing of the target area.

### FIELD OF THE INVENTION

The present invention relates to methods and apparatus to perform controlled access to any location inside a storage tank, used for storing fluids, or solids, or the mixture of fluids and solids, while it is operated, idle, or undergoing maintenance, to make an internal service from outside. More specifically, the present invention relates to a method and device for vessel cleaning in which the cleaning fluid is delivered into the tank through the oriented coded tubing and steered through the location measurement unit.

### BACKGROUND

Fluids containing solids or other distinct particles are prone to separation, with heavier content settling and concentrating at the bottom of the container or a tank, where such fluids, or solids, or the mixture of fluids and solids are stored. The various components of the liquid can also crystallize or precipitate and sediment due to the temperature or/and pressure changes during transportation and storage. Often, this separation is desirable as part of the purification or refinement process of the fluids, in which case it is important to be able to manipulate the liquid inside the storage tank to facilitate the separation, for example, to dilute or remove the sediment/deposits/sludge. In other cases, this separation is not desirable, and keeping the liquid homogeneous inside the storage tank becomes a goal. Industrial-use fluids, such as oil, construction materials, or chemicals, are often stored in tanks of such volume, weight, construction, and dimensions as to make the operation of the tank difficult, and as such required various solutions for mixing or separating the contents, as installation of permanent devices inside the tank or full drainage and manual cleaning by personnel are costly and potentially hazardous.

Over time, more sophisticated solutions have appeared. Storage tanks became equipped with access ports that allow access for various devices into the storage tank. Cleaning machines capable of ejecting heated, pressurized cleaning fluid in a straight line and often equipped with nozzles (such as U.S. Pat. No. 3,542,593) can agitate the sludge within reach of the machine, reducing the need for manual cleaning. A further improvement (US Patent 2014/0190517 A1) made it possible to clean storage tanks while in operation (i.e., without the need to drain the tank), however, this method was also limited only to the areas within the reachable straight length of the machine, leaving the perimeter of the tank, or larger areas of irregular-shaped tanks, out of reach. Are known the special structures inside the tank to allow washing heads/nozzles (active heads) delivering of washing fluid to wall evenly (U.S. Pat. No. 8,894.467 B2) or inserting into the tank the manageable device while the tank is emptied (U.S. Pat. No. 4,817,653). Are known the angled entry in the tank which treats inside volume for separation (U.S. Pat. No. 1,897,332), where tangential inlet forms the directed flow.

A similar solution to seal the rotary ball in the valve is described in the patent US Pat. No. 9,879,789.

Concurrently, a flexible tube solution referred to as coded tubing became introduced as equipment for well cleaning in the oil and gas industry (U.S. Pat. No. 5,458,198, US Patent 200802170119A1). However, in the context of an oil or gas well, it is not the multi-dimensional directed moving of a coned tubing active head in the mostly unrestricted volume, in other words, not its ability to be positioned in a way to reach any location inside a three-dimensional space, but its ability to feed a prolongated narrow hole, that was being exploited. The CT has never been introduced as a method for controlled service into the storage tanks, where its ability to bend at different angles could help facilitate access of the CT active head to various locations within the tank including the bottom and wall surface.

It's known that the nozzles are used as the CT active head to wash the bottomhole of the well (U.S. Pat. No. 6,982,008 B2), but the bending ability of CT by using differently angled nozzles can't be applied because of the restrictive space. Moreover, a known the well CT active head navigating and controlling accessories (U.S. Pat. No. 6,143,988) can't interact with external receiver/sources to manage placement inside well space because of its absence there and has limited by well space to change the direction inside the wellbore.

A flexible device that would allow manageable and safe service access through the variable guide on the wall or roof entry at various angles to any location inside the tank for cleaning with a remote control while it operated remained lacking.

### DESCRIPTION OF THE INVENTION

This invention proposes to use the access port in the tank or vessel to insert a CT, which is essentially a flexible pipe that can bend in 3D projection while introducing through a variable guide and can be directed in a desirable position inside the tank to perform a service task. The combination of such technological solutions, like CT, the rotating ball valve insulation, oriented nozzles, other active head tools, source/receiver navigation of the active head makes possible a new synergetic technological method for manageable service inside the tank.

Different variable guide flanges can be used to direct CT active head inside the tank, such as a fixed guide entry or a rotating spherical one like a ball valve, which allows smoothly adjust the CT active head directions inside the tank. Once inside the tank, it can also bend to the desired degree by diverter and can be moved forward and backward in the desired direction using an outside drive unit and/or deviate by a certain angle by hydraulic as a result of counter-action of pressurized fluid from any particular open nozzle located at various sides of the tube active head or any other mechanical or digital/robotic/autonomous means. CT can be inserted to varied lengths within the tank if using an entry point at the wall of the tank (ft using an entry point at the top of the tank, it allows straight-line access to any depth), it allows straight-line horizontal access through the conductor and deviates by a diverter or hydraulic means as a result of counter-action of pressurized fluid from any particular open nozzle located at various sides of the tube active head to any point along the diameter of a tank. The coiled tubing outside end through the stripper, which is connected to the entry point variable guide flange, the driving unit, and the reel unit provides access to the delivery unit, which can be a pump or/and vacuum device. The coiled tubing active head can be equipped with a pressurized jet spray (for cleaning fluid, diluting fluid, a gas, or any other substance being discharged or injected into the tank), or/and rotating blades or scraper vanes for mixing/replacing the contents or cleaning the interior surfaces; an insulated probe sampler, equipment for taking measurements of chemical or physical properties of the contents of the tank; video/infrared camera; equipment to navigate and local interior repair tool, or any other device.

While inside, the location of the coiled tubing needs to be monitored—both for purposes of navigation/operation and for safety (to avoid damage to the tube and/or attached devices from the walls of the tank and wall itself). A variety of monitoring means can be adopted. An optic fiber cable, or another pressure, temperature, and vibration sensor, or a variety of them can be attached to the outside of the tank. The sensor will be sensitive to the changes in temperature/pressure/vibration onto the tank walls, resulting from the service process being provided by the coiled tubing inside. In the alternative, ultrasound, sonar, or radio technology can be used to communicate the precise location of the CT active head to the operator of the equipment.

In a yet another embodiment, a combination of the two coiled tubings (or a double concentric CT, or the CT with the movable concentric pipe) can be used simultaneously; one CT or one opening for discharging a substance (such as a cleaning, or diluting, or mixing fluid, or their combination) into the tank, and another CT/pipe or another opening to remove a substance (such as the sediment/deposits/sludge) from the tank.

All nozzles used on the CT active head are chosen during the planning of the process for cleaning, removing, mixing of the sediments, sampling, and others.

The use of the term “tank” is not to exclude other types of large-volume containers. Still, it includes without limitation large containers within which sedimentary, gravitationally separated fluids, precipitated deposits, or their mix, would accumulate in the bottom, and particularly such tanks are used to store unstable fluids and their mixes with solids, crude oil, slop oil, and other grades of crude, refinery products; and other hydrocarbon and wasted fluids.

### BRIEF DESCRIPTION OF THE DRAWINGS

FIG. 1 The CT unit package is attached to the tank wall.

FIG. 2 The CT unit package is attached to the tank roof

FIG. 3 The fixed variable guide on the spherical cover on the access point valve.

FIG. 4 The fixed variable guide on the flat cover on the access point valve.

FIG. 5 The swivel spherical variable guide is placed on the access point valve.

FIG. 6 The wall entry with the delivery guide unit.

FIG. 7 The CT active head operation is represented by the angled jet nozzles.

FIG. 8 The source/receiver equipment location for CT intervention monitoring.

### DETAILED DESCRIPTION OF THE INVENTION

All processes of the invention are based on CT solution which was adopted for internal storage service.

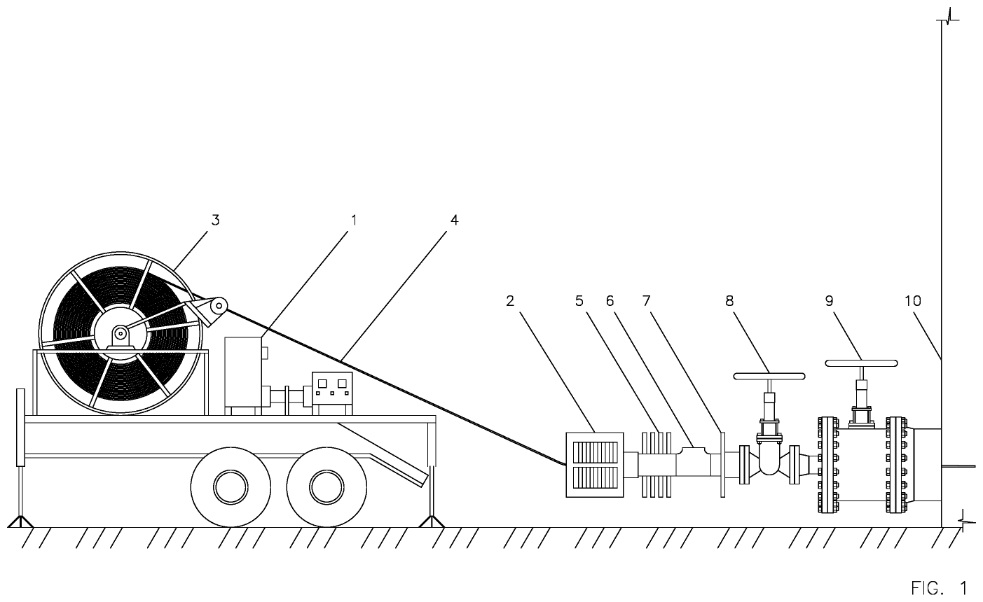

At FIG. 1 the CT unit for the controlled access from the tank wall entry point equipped with a valve to any location inside a storage tank is shown. There is the prime mover 1 which drives using drive unit 2 the CT 4 located on tubing reel 3. Then, CT is guided through the stuffing box 5, the flow tee 6, and pipe ram 7 to the connection valve 8 attached to valve 9 on the tank 10 wall entry point.

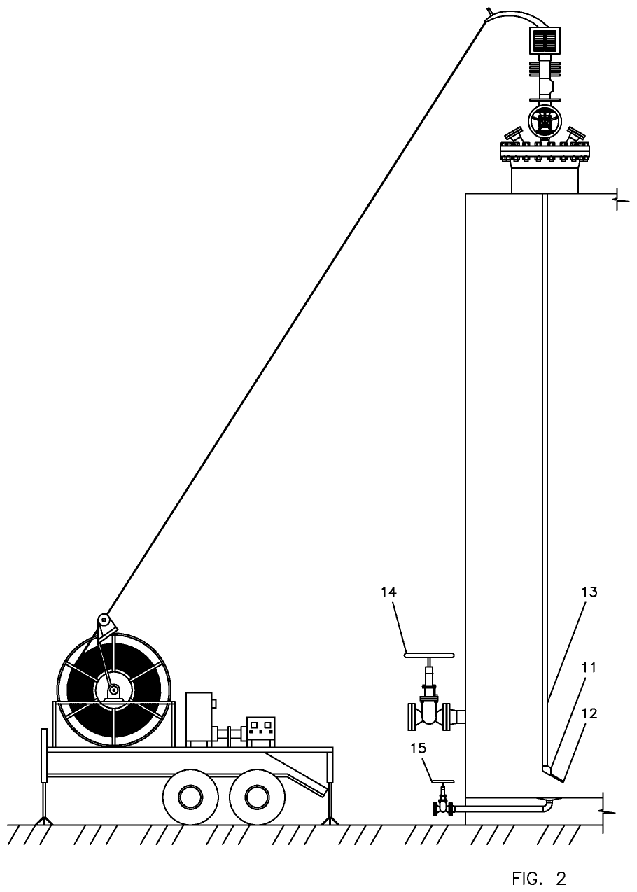

FIG. 2 is demonstrated the CT unit layout for the controlled access from the roof entry point. In this case, diverter 11 which is connected to the guide tube 13 allows directing the CT active head 12 inside the tank. There is tank filling/inlet valve 14 on the wall and drain valve 15 on the bottom of the tank.

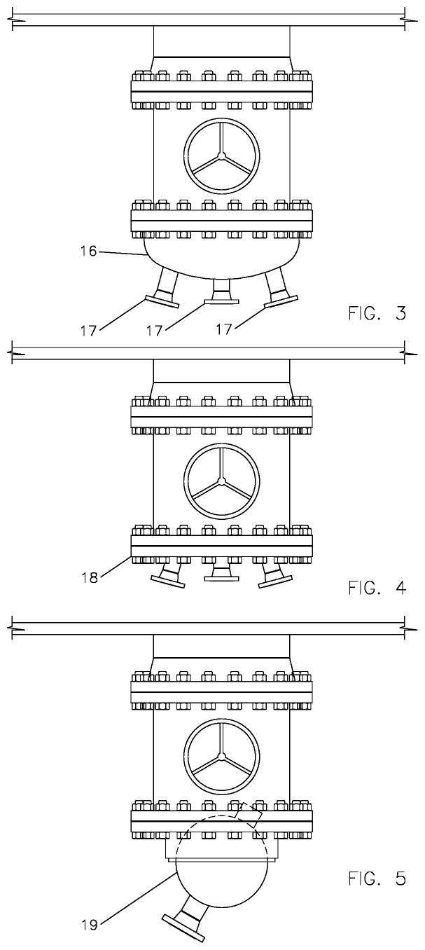

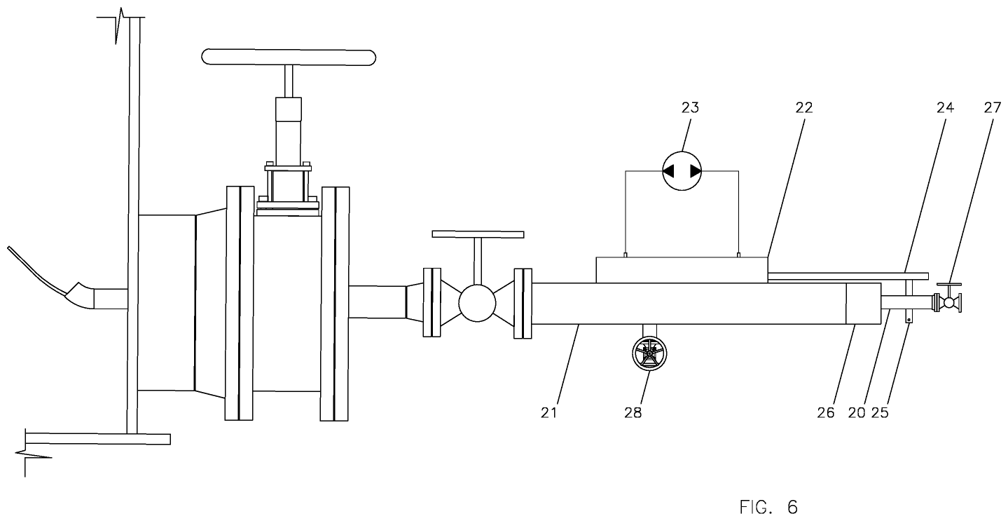

FIG. 3, 4, 5 is illustrated the variable guide covers for the coned tubing. The variable guide cover is located on the access opening or manway to connect the Coiled Tubing Unit Package to the tank on the access point. It can be rounded as position 16 with the several flange connectors 17 for the CT entrance, flat as 18, and swivel spherical variable guide unit as 19. Range connectors 17 are welded to the variable guide cover with different angles to orient initially the CT intervention from the outside in the desired direction into the tank. The rounded cover has more room before the entry point valve to place the more prolonged guiding tool for the CT after the stuffing box. The swivel spherical variable guide design allows providing the whole range variability for the CT intervention direction while the tool is introduced into the tank.

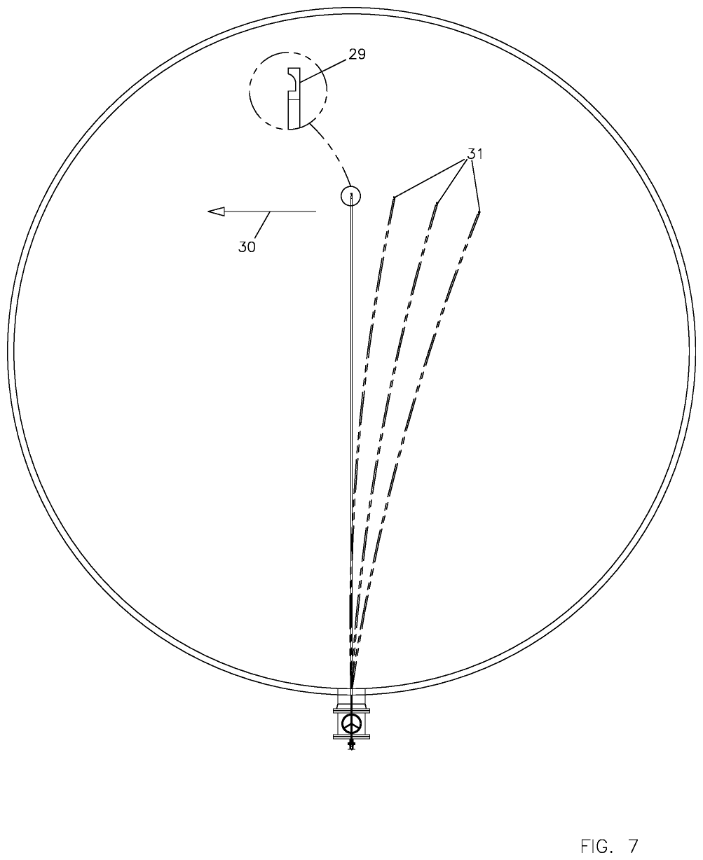

The wall entry with the delivery guide unit is shown in FIG. 6. This CT package is additionally combined with rotatable guiding tube 20 and diverter 11 to direct CT active head 12 into and inside the tank. In this case, the hydraulically powered delivery guide unit 21-24 is attached through valve 8 to guiding connector flange 17 of variable guide cover 16 (or 18, 19). CT 4 is introduced into the rotatable guiding tube using the delivery system which is connected to valve 27.

The delivery guide unit composes of the driving unit with delivery cylinder 21 of the hydraulic drive powered by pump 23 and drive cylinder 22 for reciprocating displacement guiding tube 20 by attached rod 24. The drive cylinder is attached to the delivery cylinder which in turn insulates the guiding tube and tank space by the stuffing box 26 while the operation inside the tank is performed. The hydraulically driven guiding tube with the nozzle when being inside the tank can be angled by the rotating of the guiding tube 20 when the CT is detached from valve 27 and rod 24 reconnected from the guiding tube to the other holder 25. There is valve 28 to connect tank volume to the outside reservoir for pumping out the washed waste material from the tank when vacuum pipe is connected to this valve or dispersed sediments and the waste material can be pumped out through drain 15 commonly located in the tank bottom.

The active head for manageable treatment the inside volume of the storage tank is represented in FIG. 7. There is angled nozzle 29, fluid jet flow 30, and CT inclination positions 31 to the opposite direction from the fluid jet.

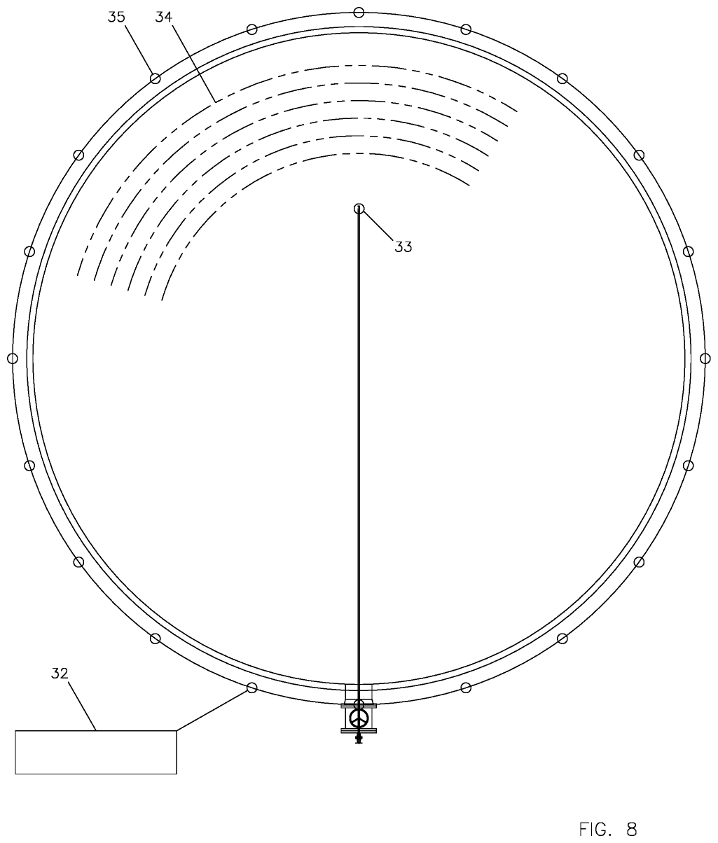

The source/receiver equipment location for CT intervention monitoring is shown in FIG. 8 and represented by the decoding unit 32, the ultrasound, sonar, piezo, or radio sensors, and/or wave sources on the CT active head 33. Possible active waves and fluid pressure/noise/vibration distribution 34 are shown inside the tank space. Fiber optic cable or/and pressure/noise/vibration sensors 35 are placed on the outside tank wall to monitor active head movement.

### Operation

The equipment parameters could include the type of nozzle, diverter, guide design, the energy and direction of nozzle jet, the diameter and type of the coiled tubing, and the choice of a cleanout fluids. Cleanout fluids are typically water, brine, oils, foams, surfactant solutions, steam, including mixtures of the above.

The cleaning/agitating parameters are a pump injection and a vacuum rate regime for cleanout or circulating fluid(s) and the CT reciprocated movement rate and the guiding pipe rotating regime, both fixed, or variable, or combined. A pump's injection/vacuum rate regime can be different for fluids or their mixtures and the goal of the process. For steam using case it is steam generator rate.

A jet nozzle action means a nozzle jet with a substantial pressure drop to provide cleaning/agitating flow pressure for the calculated distance. The equipment and cleaning agitating parameters are managed to reach effective flow rate and pressure in the goal areas of the tank adopted to the sediments properties.

Pressure and flow speed at the nozzle and the target distance can be calculated in the following sequence:

The fluid jet speed at the target distance:

νₗ=6.8*d₀*ν₀/l

Where fluid jet speed at the nozzle is as:

ν_{O}=φ\sqrt{2gH}

Pressure at the nozzle can be formulated as:

P₀=ρ*ν²o/2

Pressure at the tank wall at the target distance from the nozzle:

Pₗ=46.24*P₀(d₀/l)²

Where:

d₀—the nozzle outlet diameter,

l—the target distance,

Pₚᵤₘₚ (H)—pump pressure (pump head)

φ—the nozzle coefficient

ρ—density of the fluid

νₗ—fluid jet speed at the/distance

ν₀—water jet speed at the outlet of the nozzle

g—the gravity constant

Disturbing of the viscous sediments or particulate solids allows make them moveable and displaceable from the tank at the target distance.

Assume that we have the pumping and cleaning/agitating parameters as following:

d₀=25.4 mm

l₁=35 m—maximum target distance (estimate for the 50 m diameter tank)

l₂=1 m—minimum target distance

Pₚᵤₘₚ=1, 5 MPa or H=150 m—pump pressure (qₚᵤₘₚ=6 m³/min—maximum nozzle throughput rate. We use water and the pumping rate less than 2 m³/min)

φ=0.9—nozzle coefficient

νₗ—fluid jet speed at the I distance, m/s

ν₀—water jet speed at the outlet of the nozzle, m/s

g=9.81 m/s²

ρ=1000 kg/m³

The fluid jet speed at the target distance:

νₗ=6.8d₀ν₀/l

The fluid jet speed at the nozzle:

ν_{O}φ\sqrt{2gH}=0.9\sqrt{2*9.81*150}=48.8 m/s

The fluid jet speed at the nozzle:

vₗ₁=6.8 d₀ν₀/l₁=(6.8*0.0254 m*48.8 m/s)/35 m=0.24 m/s

νₗ₂=6.8 d0ν₀/l2=(6.8*0.0254 m*48.8 m/s)/1 m=8.4 m/s

Pressure at the nozzle:

P₀=ρ*ν²o/2=1000*48.8²/2=1.2 MPa

Pressure at the tank wall:

Pₗ₁=46.24*P₀(d₀/l₁)²=46.24*1.2*(0.0254 m/35 m)²=0.03 kPa

Pₗ₂=46.24*P₀(d₀/l₂)²=46.24*1.2 *(0.0254 m/1 m)²=35.8 kPa

To conclude the results of the calculations, we can see that there is enough flow energy for treating/cleaning of the sediments. To reach more length treating distance other pumping parameters, and/or nozzles, and/or other fluid, and/or fluid temperature may be required.

The tank cleaning process with sediments recovery is based on using of assembly which is shown on the FIG. 6. CT 4 (FIG. 1) with selected nozzle 12 (FIG. 2) is installed in guiding tube 21 with diverter 11 (FIG. 2) when valve 9 (FIG. 1) is closed. Then, after opening valve 9 the guiding tube with the diverter moves into the tank, and CT through the guiding tube and the diverter penetrates in the tank. The reciprocating movement of the CT and rotating of the guiding tube allows the nozzle to reach the goal area of the tank for cleaning/agitating. To rotate guiding tube 20 rod 24 should be detached from it, valve 27 closed, and CT injector assembly detached from the mentioned valve. After rotating the guiding tube 20 for the required angle rod 24 can be attached again to holder 25.

Upon the CT entering the sediments a pump rate will be selected based on pressure and rate calculation and the goal of the entering. To pump out sediments the vacuuming tool is attached to valve 28, while the CT with the flowing nozzle is directed by the diverter to the appropriate zone. The CT and the guiding tube can move simultaneously or separately using the CT drive and the guiding tube hydraulic drive. One more option is to disturb and make redispersed or solved sediments in the remained tank content by agitating or/and circulation by using the above-mentioned process.

Upon reaching and treating along the target length, the CT and nozzle will be pulled out until the tank entry point. The controlled speed of pulling out or pulling in of the CT and/or guiding tube of the tank, preferably selected based on the type of sediments, cleanout/circulated fluid, location of sediments, pump rate, and other process parameters.

To adjust the flow direction to the new area the jetting nozzle can be turned by the guiding tube rotation or/and by changing the CT nozzle while the entry point valve is being closed. To rotate the guiding tube the valve 27 should be closed and CT drive assembly detached.

To treat the tank from the roof the guiding tube is installed on the roof entry flange and then the operation is provided similar to the wall entry process described above.

The coiled tubing active head can be equipped with the rotating blades or scraper vanes for mixing the contents, or moving out the consolidated sediments, or cleaning the interior surfaces. The active head can be represented by the combination of the rotating blades, or scraper vanes, or both with the nozzles for cleaning/replacing the contents. In this case, the CT assembly will preferably constitute the delivering guide with the vacuum process to discharge the removed waste from the tank.

FIG. 7 illustrates using of the angled nozzle to cover the wider area of the tank because of the flexibility of the CT under the bending pressure.

To get sampling or/and take measurements an insulated probe sampler, measuring equipment for the getting chemical or physical data of the contents of the tank; video/infrared camera; equipment to navigate and local interior repair tool, or any other device can be attached to the CT as the active head.

While into, the location of the coiled tubing active head needs to be monitored—both for purposes of navigation/operation and for safety (to avoid damage to the tube and/or attached devices by contact with the wall of the tank and wall itself). A variety of monitoring means can be adopted. An optic fiber cable, or another pressure, temperature, bending stress, and vibration sensor, or a variety of them can be attached to the outside wall of the tank. The optic fiber cable/sensor will be sensitive to the changes in temperature/pressure/vibration/bending stress onto the tank wall, resulting from the service process being provided by the coiled tubing inside. In the alternative, ultrasound, sonar, or radio technology can be used to communicate the precise location of the CT active head to the operator of the equipment. FIG. 8 demonstrates the interaction between the source of waves and receiver to control the CT active head location.

Real-time monitoring of the process can allow the altering of the pump/vacuum parameters and speed of the CT forward-backward movement.

The instant invention offers the safe and accurate process through the CT job design and real-time control, the whole range of the service operations with the active head while the tank operated.

The foregoing description of the equipment of the invention is presented for purposes of illustration and description and is not intended to be exhaustive or to limit the invention to the precise form. The description was selected to best explain the principles of the invention and their practical application to provide a base for best utilize the invention by professionals in various applications. Various modifications as are best suited to the particular use are contemplated. It is intended that the scope of the invention is not to be limited by the specification but to be defined by the claims set forth below.

1. Method and equipment to perform the access to the projected location inside a fluid, solids, or the mixture of fluid and solids storage tank, while it is operated, idle, or undergoing maintenance, to make an internal service from outside, which comprises controlled introduction into the tank from the wall or a roof access point outside of the tank through a guide unit placed on the access point and/or beyond it, using the coiled tubing (CT) with the active head on the end, and the CT drive on the other end which provides controlled reciprocating movement of the CT active head inside the tank under different angles in 3D projections set by the variable guide mounted on the access point and/or a diverter inside the tank and/or angled jet nozzles to cover a whole target area.

2. The method as claimed in claim 1 when through the active head as a nozzle agitating or/and cleaning fluid is delivered inside the tank with sediments by means a pump to make a slurry movable or/and pumping out the made slurry by the vacuum unit from the outside source.

3. The method as claimed in claim 2 when fluid is represented by fluid stored in the tank and circulated through the CT from the other access point or drain to the active head.

4. The method as claimed in claim 1 when the CT is used to remove, and recovery treated sludge or dispersed deposits by means of the vacuum unit combined with the CT guiding unit.

5. The method as claimed in claims 2 and 4 when cleaning/agitating fluid is directed to pumping out treated area of the first CT by the other CT through the appropriate tank access point.

6. The method as claimed in claims 3 and 4 when cleaning fluid circulated through double concentric tubing, where inside tubing is CT which used for injection cleaning fluid and annulus to vacuum treated sludge or dispersed deposits.

7. The method as claimed in claims 2, 3, 4, 5, and 6 when cleaning/agitating fluid is heated.

8. The method as claimed in claim 1 when CT intervention monitored and controlled by the measuring of the pressure, vibration, bending stress, and temperature through fiber optic cable, or any other sensors or technology applied on the surface around of the outside tank wall on the height between the tank bottom and the intervention point elevation.

9. The method as claimed in claim 1 when the CT active head represented by the testing end which provides a specific survey of the defined area of the tank.

10. The method as claimed in claim 1 when the CT active head provides a delivery of the repair material to the defined maintain area of the tank.

11. The method as claimed in claims 2, 3, 4, 5, and 6 when cleaning/agitating fluid type and/or composition are customized depending on the nature, composition, chemical and rheological properties of the sediment.

12. The method as claimed in claims 2, 3, 4, 5, and 6 when cleaning/agitating fluid type and composition are modified during the cleaning process to optimize the process performance and efficiency.

13. A device for the controlled access into the tank, comprising the CT with the active head introducing in the tank through the variable guide unit on the access point connected with a delivery guide with the rotatable hydraulically moved guiding tube, and another end of the CT powered by the CT drive unit for moving CT to the delivery system.

14. A device, as claimed in claim 13 having the diverter for the CT on the head of the guiding tube which being introduced inside the tank allows to control direction of the CT active head movement.

15. A device, as claimed in claim 13, having as the active head nozzles and/or scraper vanes or rotating blades depending on the density of deposit.

16. A device, as claimed in claim 13, comprising a guide unit on the roof manway for putting CT from outside the tank having nozzle and/or rotating vanes or blades as the active head angled into the floor and/or the wall of the tank.

17. A device, as claimed in claim 13 in which the CT and all surfaces liable to be brought into contact with the interior surface of the tank are composed or/and covered by the material which is flexible and/or slide easily and give protection against scratching on the said interior surface of the said tank.

18. A device, as claimed in claim 13 having as active head the nozzle that can orient the flow for changing the position of the CT inside the tank with the maximum volume and surface coverage.

19. A device, as claimed in claim 13 having as the active head the sampling unit which provides an insulation and delivery of the samples from the defined area of the tank.

20. A device, as claimed in claim 13 having as the active head a placement unit to deliver repair material to the defined area of the tank.

21. A device, as claimed in claim 13 having as the active head ultrasound, sonar, or radio sensors for CT intervention monitoring and controlling.

22. A device for CT intervention monitoring and controlling by the measuring of the pressure, vibration, and temperature through fiber optic cable placed on the outside tank wall and equipped with decoding unit to define pressure, vibration, and/or temperature changes and locate the active head position and tank's treatment response.
